(19) United States
(12) Patent Application Publication
(10) Pub. No.: US 2006/0280439 A1
(43) Pub. Date: Dec. 14, 2006

(54) Environment responsive digital device control apparatus and method

(76) Inventors: Kaoru Ukai, Ome-shi (JP); Masahiko Mawatari, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/407,080

(22) Filed: Apr. 20, 2006

(30) Foreign Application Priority Data
May 31, 2005 (JP) 2005-160614

(51) Int. Cl. H04N 5/91

(52) U.S. Cl. 386/94

(57) ABSTRACT

According to one embodiment, disconnection/connection of external devices networked as connected devices is automatically detected, and connection environment of the external devices is grasped, so that various functions can be controlled. A disconnection/connection detecting unit detects whether an external device is connected to or disconnected. An authentication unit conducts a mutual authentication when the external device is connected. When the external device is disconnected while the recording medium is being reproduced, a positional information processing unit causes positional information concerning a position being reproduced to be stored. When the external device reconnected again, a reproduction start control unit starts a reproduction of the recording medium according to the positional information.

### CROSS-REFERENCE TO RELATED APPLICATIONS

This application is based upon and claims the benefit of priority from Japanese Patent Application No. 2005-160614, filed May 31, 2005, the entire contents of which are incorporated herein by reference.

### BACKGROUND

1. Field

One embodiment of the invention relates to an environment-responsive digital device control apparatus and method, for example, a signal output apparatus and a signal output method for outputting digital signals such as video and audio to another externally connected receiving device or display apparatus.

2. Description of the Related Art

As is well known, a digital visual interface (DVI) standard is widespread as a standard for transmitting a digital video signal. In recent years, a high definition multimedia interface (HDMI) standard is increasingly adopted as a digital signal transmission standard improved further from the DVI standard.

The HDMI standard include various provisions that are not included in the DVI standard, such as: it is possible to perform an audio transmission by multiplexing a digital audio signal in a blanking period of a digital video signal; it is possible to transmit a digital video signal in a form of a YCbCr signal, or in a higher-definition form of a YPbPr signal, as well as to transmit a digital video signal in a form of an RGB signal; and it is possible to connect with a universal serial bus (USB)-like small-sized HDMI connector.

Besides, according to the HDMI standard, authentication may be conducted between a transmitting device and a receiving device prior to transmitting a signal, so that the transmitting device can output the signal in a form suited to performance of a receiving device. That is, the transmitting device acquires extended display identification data (EDID) from the receiving device, thereby recognizes a receiving specification of the receiving device, and outputs the signal in a form suited thereto.

By the way, it is recently common to connect a plurality of external devices (a recording/reproducing apparatus, a reproducing apparatus, a display apparatus, etc.) to one apparatus. Besides, a new external device is often added or changed.

Under such circumstances, a transmission system for a digital signal in conformity with the HDMI standard is required to have further enhanced functions. Especially, in cases of connection/disconnection of an external device, additional connection of a new device, and connection switching, these cases are desired to be responded to.

For example, Jpn. Pat. Appln. KOKAI Publication No. 11-311983 discloses a technique in which various monitors can be connected to an image composition section, and a system control unit discriminates a characteristic of the connected monitor. Then, a characteristic of video data output to the monitor is changed according to the discriminated characteristic.

In recent years, however, it is common to connect a plurality of external devices (a recording/reproducing apparatus, a reproducing apparatus, a display apparatus, etc.) to one apparatus, as mentioned above. Besides, frequent disconnection/connection of a recording device is often performed. Further, a new external device is often added or changed. That is, connected devices are networked. Therefore, it is insufficient to simply discriminate the characteristic of the monitor and just to change the output characteristic.

### BRIEF SUMMARY OF THE INVENTION

According to one embodiment of the invention, there is provided an environment-responsive digital device control apparatus adapted to prevent inconvenience even when connected devices are networked, and particularly, adapted to automatically detect disconnection/connection of external devices, grasp connection environment of external devices, and control various functions.

In order to attain the above object, in the embodiment of the invention, there is provided an environment-responsive digital device control apparatus comprising: an information processing unit which processes a signal reproduced from a recording medium; a plurality of connector units; a disconnection/connection detecting unit which detects whether an external device is connected to any one of the connector units, or whether an external device is disconnected; an authentication unit which conducts a mutual authentication when the external device is connected to the connector unit; a positional information processing unit which, when the disconnection/connection detecting unit detects disconnection of the external device while the recording medium is being reproduced, causes positional information concerning a position being reproduced to be stored; and a reproduction start control unit which, when the disconnection/connection detecting unit detects connection of a device and the device is the external device reconnected, starts a reproduction of the recording medium according to the positional information.

By the above-mentioned means, an appropriate system operation can be attained without causing inconvenience to a user even in a networked environment in which external devices are disconnected/reconnected, added, or changed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the configuration of one embodiment of the present invention;

FIG. 2 is an exemplary block diagram showing the configuration of another embodiment of the present invention;

FIG. 3 is an exemplary diagram showing the configuration of a substantial part of one embodiment of the present invention;

FIG. 4 is an exemplary diagram showing the configuration of a substantial part of another embodiment of the present invention;

FIG. 5 is an exemplary flowchart showing an operation of a substantial part of the present invention; and

FIG. 6 is an exemplary flowchart showing another operation of a substantial part of the present invention.

### DETAILED DESCRIPTION

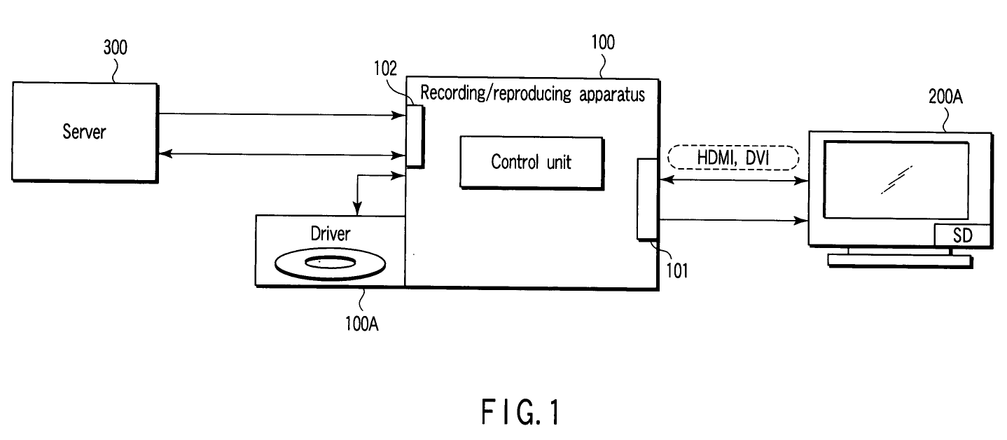

Various embodiments according to the invention will be described hereinafter with reference to the accompanying drawings. In FIG. 1, reference numeral 100 indicates, for example, a reproducing apparatus, and includes a drive unit 100A for reproducing a hard disk or an optical disk. The reproducing apparatus 100 may include a drive unit that reproduces both a hard disk and an optical disk. The reproducing apparatus 100 includes a plurality of connector units 101 and 102. The connector unit 101 is connected with, for example, a television receiver 200A for displaying a standard video signal as an external device. The connector unit 101 is also connected with a server 300 via the Internet.

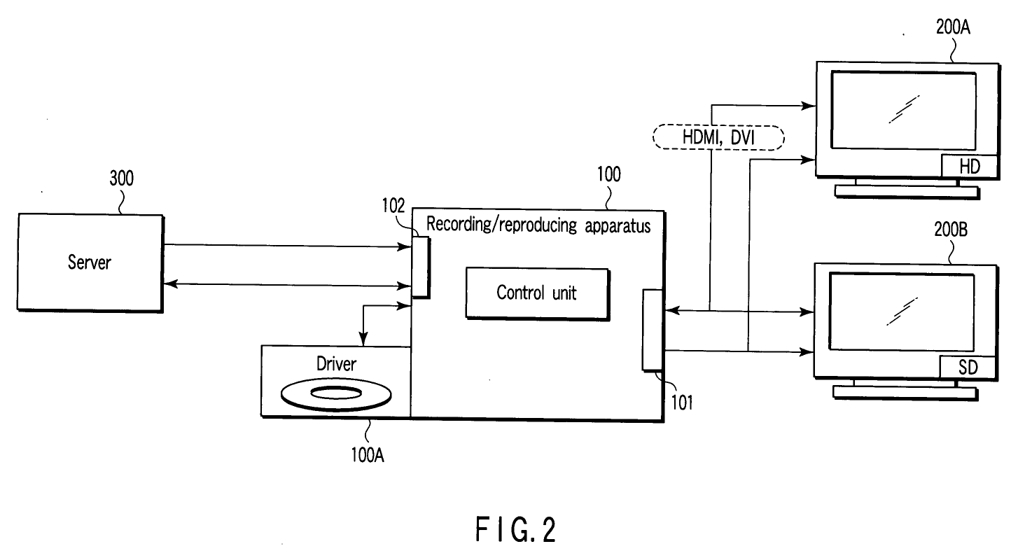

FIG. 2 shows that the connector unit 101 can also be connected with a television receiver 200B for displaying a high-definition video signal. Other components in FIG. 2 have the same configuration of those of FIG. 1, and are therefore indicated by the same reference marks. An HDMI standard according to the invention is applied to the connection between the above-mentioned television receiver 200A or 200B and the reproducing apparatus 100.

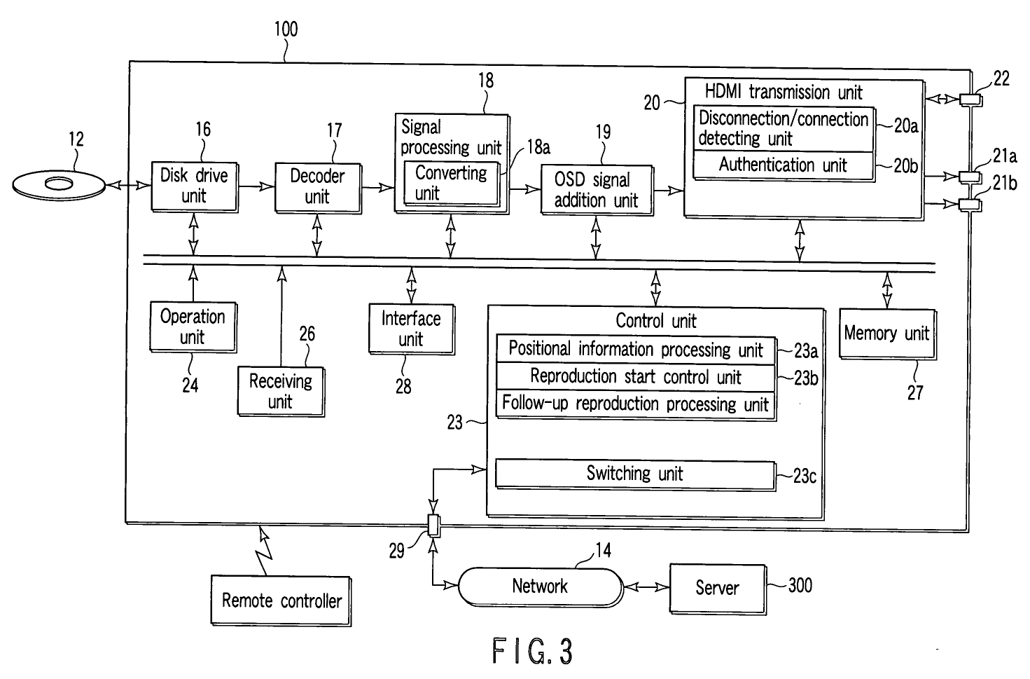

FIG. 3 shows an exemplary internal configuration of the above-mentioned reproducing apparatus (for example, an optical disk reproducing apparatus).

In the optical disk reproducing apparatus 100, an optical disk 12 such as, for example, a digital versatile disk (DVD) is loaded in a disk drive unit 16 (corresponding to 100A in FIG. 1). When a reproduction is requested, recorded data thereon is read.

The data read by the disk drive unit 16 is supplied to a decoder unit 17 and a signal processing unit 18 to be sequentially subjected to a digitization process, an error correction process, a decoding process, etc., and is thereby restored to a digital video signal.

The restored digital video signal is supplied to an on-screen display (OSD) signal addition unit 19, so that an OSD signal is added to the restored digital video signal. Then, the restored digital video signal is supplied to an HDMI transmission/reception unit 20 to be converted into a form in conformity with the HDMI standard, and is led out to a receiving device (i.e., the television receiver 200A or 200B in this case) via output terminals 21a, 21b.

Besides, the HDMI transmission/reception unit 20 can make a communication with the receiving device (i.e., the television receiver) via an input/output terminal 22.

For example, the HDMI transmission/reception unit 20 can request acquisition of EDID. Further, the HDMI transmission/reception unit 20 can acquire EDID output from the receiving device via the input/output terminal 22.

The optical disk reproducing apparatus 100 is controlled by a control unit 23 as a whole in all operations thereof including the above-described reproduction operation. The control unit 23 incorporates a central processing unit (CPU), etc. The control unit 23 receives operation information from an operation unit 24, or operation information from a receiving unit 26 for receiving a signal transmitted from a remote controller 25, and controls each unit such that operation contents thereof are reflected.

In this case, the control unit 23 uses a memory unit 27. The memory unit 27 mainly includes a read only memory (ROM) having stored therein a control program to be executed by the CPU, a random access memory (RAM) which provides the CPU with a work area, and a nonvolatile memory which stores various settings information, control information, etc.

The control unit 23 can make an access request via an interface unit 28 and a connection terminal 29 to a data server 15 connected to a network 14, thereby acquiring a desired video signal from the data server 15.

The video signal acquired from the data server 15 is supplied to the signal processing unit 18 to be subjected to a predetermined signal processing, and an OSD signal is added thereto by the OSD signal addition unit 19. Then, the video signal is converted by the HDMI transmission/reception unit 20 into a form in conformity with the HDMI standard, and is led out to the receiving device via the output terminals 21a, 21b.

Here, the control unit 23 may also recognize a receiving specification of the television receiver according to the EDID acquired by the HDMI transmission/reception unit 20, and can retrieve a video signal in a form compliant with the receiving specification from the optical disk 12 or the data server 15 to thereby output the video signal to the television receiver.

For example, if a display specification of the television receiver is a standard definition (SD) specification, the control unit 23 retrieves a video signal compliant with SD from contents of the optical disk 12 or the data server 15, and outputs the video signal to the television receiver.

If the display specification of the television receiver is an high definition (HD) specification, the control unit 23 retrieves a video signal compliant with HD from contents of the optical disk 12 or the data server 15, and outputs the video signal to the television receiver.

In this case, it is assumed that the video signal compliant with SD and the video signal compliant with HD are prepared in the optical disk 12 or the data server 300 for the same contents requested to be viewed by a user.

Here, the HDMI transmission unit 20 and the control unit 23 of FIG. 3 together constitute a characteristic portion of the present invention. That is, for example, the HDMI transmission unit 20 is provided with a mutual authentication unit 20b which conducts a mutual authentication when an external device is connected. The operation by the mutual authentication unit 20b is to verify whether or not the connected device satisfies a predetermined condition. Only when the condition is satisfied, mutual exchange of data, and reception or transmission of contents, are enabled. Further, the HDMI transmission unit 20 is provided with a disconnection/connection detecting unit 20a which detects whether or not an external connection device is connected to a connection terminal. When the disconnection/connection detecting unit 20a detects that an external device is connected, the authentication unit 20b performs an authentication process.

On the other hand, the control unit 23 includes a positional information processing unit 23a, a reproduction start control unit 23b, and a switching unit 23c. The reproduction start control unit 23b also includes a follow-up reproduction processing unit as described hereinafter.

When the disconnection/connection detecting unit 20a detects disconnection of the external device while the recording medium 12 is being reproduced, the positional information processing unit 23a causes positional information concerning a position being reproduced to be stored. The positional information may be held in the positional information processing unit 23a, or may also be held in a reproducing unit that is reproducing the recording medium 12. Further, a resume information recording function of the recording medium 12 may be used. The positional information may be recorded in a specific management information position on the recording medium 12 as resume information.

When the disconnection/connection detecting unit 20a detects connection of a device that is the same external device reconnected, the reproduction start control unit 23b controls a reproduction start for the recording medium according to the positional information.

Further, the present apparatus has the following functions. For example, when the television receiver 200A is disconnected, and then the another television receiver 200B is connected, a signal processing in accordance with a capability thereof is performed. Now, it is assumed that the television receiver 200B is connected when the disconnection/connection detecting unit 20a detects connection of a device, and that this device has a reproducing capability different from the television receiver 200A connected immediately before. Then, the reproduction start control unit 23b reproduces contents (for example, a high-definition television signal) that conform to the television receiver 200B from the recording medium 12. Alternatively, the reproduction start control unit 23b includes the switching unit 23c which, in the case where only standard video data is stored in the recording medium, converts the number of scanning lines, etc., of a standard television signal, produces an interpolation signal, and converts and outputs the base signal. Therefore, a scanning line converting unit 18a is provided in the signal processing unit 18.

In the above-described embodiment, a basic configuration section of the present invention is provided in the reproducing apparatus 100. However, the basic configuration of the present invention may be constituted independently, or may be provided in the television receiver.

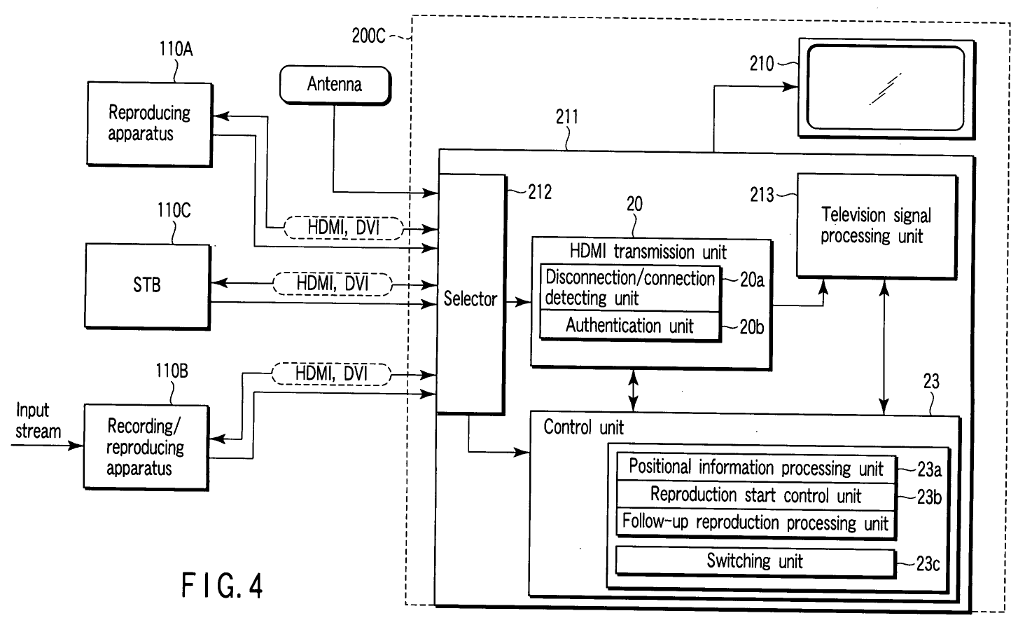

FIG. 4 shows an exemplary configuration of a television receiver 200C. The television receiver 200C is shown separately as a display unit 210 and a main board 211. A selector 212 including a plurality of connector units is provided on the main board 211 so that external devices can be connected. In this example, a reproducing apparatus 110A, a set top box (STB) 110C and a recording/reproducing apparatus 110B are connected. An antenna is also connected. The selector 212 can switch any one of the external connection devices selectively to connect to the HDMI transmission unit 20. A signal acquired via the HDMI transmission unit 20 is processed in a television signal processing unit 213, and is supplied to the display unit 210. The control unit 23 is also provided in the television receiver 200C, and controls the system as a whole.

Also in the above-mentioned HDMI transmission unit 20 and the control unit 23, as above in FIG. 3, the disconnection/connection detecting unit 20a and the authentication unit 20b are provided, and the positional information processing unit 23a, the reproduction start control unit 23b and the follow-up reproduction processing unit are provided, respectively.

The above-mentioned system also includes an information processing unit which processes a signal reproduced from a recording medium, and a plurality of connector units. Besides, the system includes the disconnection/connection detecting unit 20a which detects whether an external device is connected to any one of the connector units, or whether an external device is disconnected, and the authentication unit 20b which conducts a mutual authentication when the external device is connected to the connector unit. Further, the system includes the positional information processing unit 23a which causes positional information concerning a position being reproduced to be stored, when the disconnection/connection detecting unit detects disconnection of the above-mentioned external device while the recording medium of the recording/reproducing apparatus 110B or 110A is being reproduced. Here, the system includes the reproduction start control unit 23b which starts a reproduction of the recording medium according to the positional information, when the disconnection/connection detecting unit detects connection of a device, and the device is the external device (the recording/reproducing apparatus 110B or 110A) reconnected. The positional information in this process may be held in the positional information processing unit 23a, or may also be held in the reproducing unit that is reproducing the recording medium 12. Further, a resume information recording function of the recording medium 12 may be used. The positional information may be recorded in a specific management information position on the recording medium 12 as the resume information.

Now, it is assumed that a stream from a digital tuner is acquired into the recording/reproducing apparatus 110B. It is also assumed that, in the television receiver 200, a signal acquired via the recording/reproducing apparatus 110B is processed and displayed on the display 210. In this course, a recording may be performed in the recording/reproducing apparatus 110B.

Here, it is assumed that the selector 212 is controlled to temporarily switch to the reproducing apparatus 110A. Then, when the recording/reproducing apparatus 110B is disconnected, the disconnection is detected by the HDMI transmission unit 20. Here, the recording/reproducing apparatus 110B starts a recording of an ongoing program (if the recording has already been performed, the recording is continued). Then, positional information concerning a position on the medium at which the recording is started is recognized by the positional information processing unit 23a, and the information is held in either unit or position. When the recording has already been performed, positional information upon continuing the recording is stored.

Next, when the reproducing apparatus 110A is disconnected and the recording/reproducing apparatus 110B is reconnected, the positional information stored above is used. Then, the recording/reproducing apparatus 110B is controlled to a reproduction state of the information recorded immediately after the recording/reproducing apparatus 110B is disconnected. The recording/reproducing apparatus 110B is in a follow-up reproduction state, and continues to record received information.

Also in the follow-up reproduction state, the recording/reproducing apparatus 110B can be controlled to a skip reproduction mode or a fast-forward reproduction mode by operation. Then, previously recorded information is reproduced to catch up with information currently being recorded.

At this point, the recording/reproducing apparatus 110B stops the recording, and the receiver 200C acquires the stream directly from the digital tuner which has been acquired via the recording/reproducing apparatus 110B, and reproduces the stream. In this regard, however, if the recording/reproducing apparatus 110B is operated in a recording mode, this recording/reproducing apparatus 110B continues the recording.

Note that not only the positional information of the information recording/reproducing apparatus 110B, but interruption position information of the reproducing apparatus 110A may also be stored when reproduction of the reproducing apparatus 110A is interrupted.

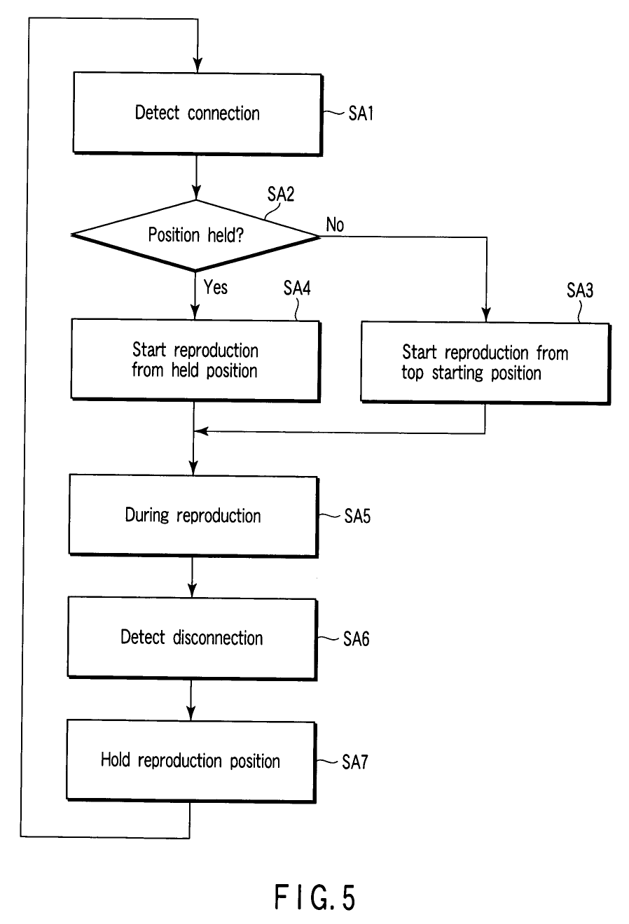

FIG. 5 is a flowchart showing a basic operation of the present invention. When a connection of an external device is detected (step SA1), it is determined whether or not positional information is held (step SA2). When positional information is not stored, a reproduction is started from a top starting position of an information recording medium (step SA3). When positional information is stored, a reproduction from an interruption position is started according to the positional information, as described above (step SA4).

In a reproduction state, it is being checked whether or not the connected device is disconnected (steps SA5, SA6). When the disconnection is detected, a reproduction position at this point is stored in a memory as interruption information (i.e. positional information) (step SA7).

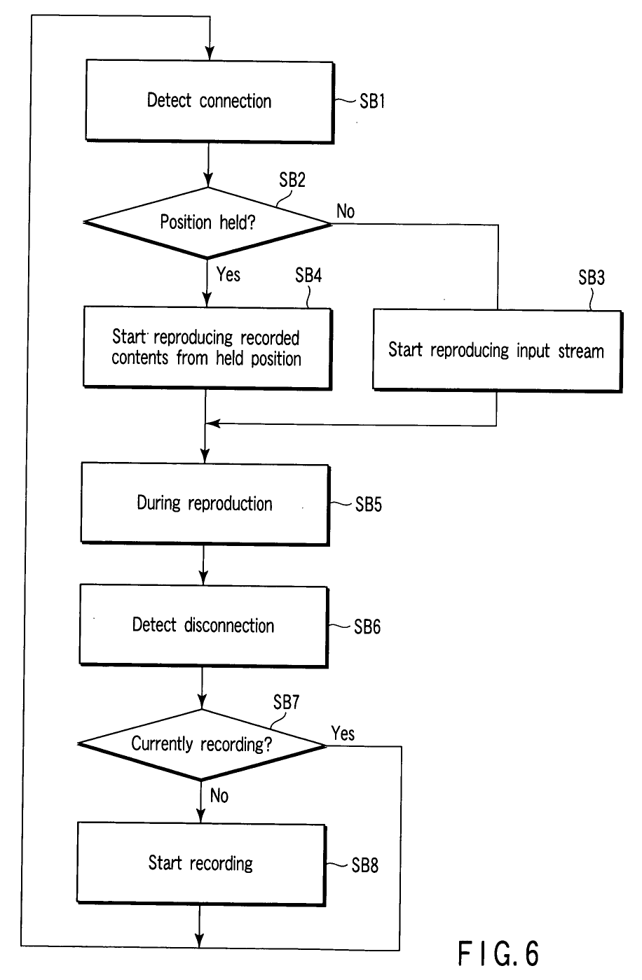

FIG. 6 is a flowchart further showing another example of a basic operation of the present invention. When a connection of an external device is detected (step SB1), it is determined whether or not positional information is held (step SB2). When positional information is not stored, a reproduction of an input stream is started (step SB3). When positional information is stored, a reproduction from an interruption position is started according to the positional information, as described above (step SB4).

In a reproduction state, it is being checked whether or not the connected device is disconnected (steps SB5, SB6). It is determined whether or not the external device is currently recording (step SB7). When a recording mode is not set, a recording is started (step SB8). When a recording mode is set, the recording is continued.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An environment-responsive digital device control apparatus comprising:
an information processing unit which processes a signal reproduced from a recording medium;
a plurality of connector units;
a disconnection/connection detecting unit which detects whether an external device is connected to any one of the connector units, or whether an external device is disconnected;
an authentication unit which conducts a mutual authentication when the external device is connected to the connector unit;
a positional information processing unit which, when the disconnection/connection detecting unit detects disconnection of the external device while the recording medium is being reproduced, causes positional information concerning a position being reproduced to be stored; and
a reproduction start control unit which, when the disconnection/connection detecting unit detects connection of a device and the device is the external device reconnected, starts a reproduction of the recording medium according to the positional information.

2. The environment-responsive digital device control apparatus according to claim 1, wherein
the external device is a display apparatus.

3. The environment-responsive digital device control apparatus according to claim 1, wherein
the external device is an information reproducing apparatus which supplies reproduction information of the recording medium to the connector unit.

4. The environment-responsive digital device control apparatus according to claim 1, wherein
the positional information processing unit causes the positional information concerning the position being reproduced to be stored in an information reproducing apparatus which is the external device connected to the connector unit.

5. The environment-responsive digital device control apparatus according to claim 2, wherein
when the disconnection/connection detecting unit detects connection of a device, and the device is a second display apparatus having a reproducing capability different from a first display apparatus connected immediately before,
the reproduction start control unit reproduces reproduction contents of the recording medium which conforms to the second display apparatus, or has a switching unit which converts and outputs a reproduced output.

6. The environment-responsive digital device control apparatus according to claim 5, wherein
the first display apparatus is an apparatus adapted to a standard (SD) video signal, and the second display apparatus is an apparatus adapted to a high definition (HD) video signal.

7. The environment-responsive digital device control apparatus according to claim 5, wherein
contents of both the standard (SD) video signal and the high definition (HD) video signal are recorded in the recording medium.

8. The environment-responsive digital device control apparatus according to claim 5, wherein
the information processing unit includes a signal processing unit which converts the number of scanning lines of a video signal.

9. The environment-responsive digital device control apparatus according to claim 1, wherein
the information reproducing apparatus is an apparatus which also performs an information recording, and
the reproduction start control unit makes a control so that the information reproducing apparatus performs an automatic recording when the information reproducing apparatus is disconnected from the connector unit while an output of the information reproducing apparatus is being monitored, and that the information reproducing apparatus performs a reproduction from a starting position at which the automatic recording is started when the information reproducing apparatus is reconnected.

10. The environment-responsive digital device control apparatus according to claim 9, wherein
the information reproducing apparatus continues the recording even after the reproduction from the starting position is started.

11. The environment-responsive digital device control apparatus according to claim 10, wherein
the reproduction start control unit makes a control so that the information reproducing apparatus performs a follow-up reproduction of a recorded part even while the information reproducing apparatus continues the recording.

12. An environment-responsive digital device control method for an apparatus having an information processing unit which processes a signal reproduced from a recording medium, a plurality of connector units, and a control unit which controls an operation of the apparatus, the control method comprising:
detecting whether an external device is connected to any one of the connector units, or whether an external device is disconnected;
conducting a mutual authentication when the external device is connected to the connector unit;
when the disconnection/connection detecting unit detects disconnection of the external device while the recording medium is being reproduced, causing positional information concerning a position being reproduced to be stored; and
when the disconnection/connection detecting unit detects connection of a device and the device is the external device reconnected, starting a reproduction of the recording medium according to the positional information.

13. The environment-responsive digital device control method according to claim 12, wherein
the external device is an information recording/reproducing apparatus which performs a recording/reproduction of information, the method further comprising:
making a control so that the information recording/reproducing apparatus performs an automatic recording when the information recording/reproducing apparatus is disconnected from the connector unit while an output of the information recording/reproducing apparatus is being monitored, and that the information recording/reproducing apparatus performs a reproduction from a starting position at which the automatic recording is started when the information recording/reproducing apparatus is reconnected.

14. The environment-responsive digital device control method according to claim 13, further comprising:
causing the information recording/reproducing apparatus to continue the recording even after the information recording/reproducing apparatus starts the reproduction from the starting position.

15. The environment-responsive digital device control method according to claim 13, further comprising:
making a control so that the information recording/reproducing apparatus performs a follow-up reproduction of a recorded part even while the information recording/reproducing apparatus continues the recording.
